(19) United States
(12) Patent Application Publication
(10) Pub. No.: US 2013/0048203 A1
(43) Pub. Date: Feb. 28, 2013

(54) FILM ASSEMBLIES WITH REMOVABLE OPPOSING TABS AND METHODS FOR APPLYING THE SAME

(71) Applicants: Bernard Kin Bong Yau, Quarrybay (HK); Tina Huff, Laguna Niguel, CA (US)

(72) Inventors: Bernard Kin Bong Yau, Quarrybay (HK); Tina Huff, Laguna Niguel, CA (US)

(73) Assignee: TARGUS INTERNATIONAL GROUP, INC., Anaheim, CA (US)

(21) Appl. No.: 13/217,089

(22) Filed: Aug. 24, 2011

(51) Int. Cl. B44C 1/17; B32B 38/18; B32B 7/06

(52) U.S. Cl. 156/230; 428/41.7; 156/537; 428/41.3; 428/41.5

(57) ABSTRACT

According to various embodiments, a film assembly may include a protective film, first and second removable opposing tabs, an adhesive, and a split release liner. The first and second opposing tabs may be configured to facilitate the alignment of the protective film with respect to a surface of a portable electronic device. Once aligned, a minority portion of the split release liner may be removed exposing a minority portion of the protective film coated with the adhesive. The minority portion of the protective film may then be adhered to the surface of the portable electronic device. Subsequently, the remaining sections of the split release liner may be removed and the protective film may be fully adhered to the surface of the portable electronic device. Once fully adhered, the first and second opposing tabs may be removed.

### TECHNICAL FIELD

The present disclosure relates generally to adhesive films configured to be applied to and protect exposed surfaces.

### BRIEF DESCRIPTION OF THE DRAWINGS

Non-limiting and non-exhaustive embodiments of the disclosure are described, including various embodiments of the disclosure with reference to the figures, in which:

FIG. 1 illustrates a top view of an exemplary film assembly configured with a split release liner and opposing tabs.

FIG. 2A illustrates a perspective view of an exemplary film assembly positioned above a portable electronic device (PED).

FIG. 2B illustrates a perspective view of the exemplary film assembly as a minority portion of the split release liner is removed from an adhesive lining an underside of a protective film.

FIG. 2C illustrates a perspective view of the exemplary film assembly with the minority portion of the protective film adhered to a portion of the PED.

FIG. 2D illustrates a perspective view of the exemplary film assembly as a majority portion of the split release liner is removed.

FIG. 3 illustrates a perspective view of the protective film fully adhered to a display screen of a PED, according to one embodiment.

FIG. 4A illustrates a top view of an exemplary film assembly misaligned with respect to an underlying PED.

FIG. 4B illustrates a top view of the exemplary film assembly aligned with respect to the underlying PED.

FIG. 4C illustrates a top view of the exemplary film assembly with a minority portion of a protective film adhered to a portion of the PED.

FIG. 4D illustrates a top view of the exemplary film assembly as a majority portion of the split release liner is removed.

FIG. 5A illustrates a top view of a protective film fully adhered to a display screen of a PED with opposing tabs in place, according to one embodiment.

FIG. 5B illustrates a top view of a protective film fully adhered to a display screen of a PED with opposing tabs in place, according to an alternative embodiment.

FIG. 5C illustrates a top view of the protective film fully adhered to the display screen of the PED with the opposing tabs removed, according to one embodiment.

FIG. 6 provides a flow chart of an exemplary method for adhering a protective film to a surface of a PED using removable opposing tabs.

FIG. 7 provides a flow chart of another exemplary method for adhering a protective film to a surface of a PED using removable opposing tabs.

In the following description, numerous specific details are provided for a thorough understanding of the various embodiments disclosed herein. The systems and methods disclosed herein can be practiced without one or more of the specific details, or with other methods, components, materials, etc. In addition, in some cases, well-known structures, materials, or operations may not be shown or described in detail in order to avoid obscuring aspects of the disclosure. Furthermore, the described features, structures, or characteristics may be combined in any suitable manner in one or more alternative embodiments.

### DETAILED DESCRIPTION

The present disclosure provides various embodiments of a film assembly including protective film and removable opposing tabs. Additionally, the present disclosure provides methods for applying the protective film to a surface of a portable electronic device (PED). According to various embodiments, a film assembly may comprise a protective film, removable opposing tabs extending from the protective film, an adhesive, and a release liner. An underside of the protective film may be coated with the adhesive. The adhesive may be designed to selectively adhere the protective film to a surface of a PED. The release liner may be configured to selectively line the adhesive prior to adhesion, such as during transport and/or handling to prevent accidental adhesion.

According to various embodiments, the protective film may comprise any of a wide variety of materials or combinations thereof, such as polyester, polypropylene, and/or polyethylene. The protective film may be configured to be adhered to and protect a display of a PED. Accordingly, at least after adhesion to the surface of the display, the protective film and the adhesive may be transparent. Alternatively, the protective film may be configured with any number of colors and/or designs.

According to various embodiments, the protective film may be configured with removable and opposing tabs configured to facilitate the alignment of the protective film with respect to a surface. According to various embodiments, the opposing tabs may be constructed of the same material as the protective film or constructed of a different material. The opposing tabs may be parallel to the plane of the protective film. Alternatively, a tab or a portion thereof may be at an angle with respect to the plane of the protective film. Furthermore, the opposing tabs may be of any size and/or shape to provide a suitable area for a user to grasp and manipulate the orientation of the protective film with respect to a surface.

According to various embodiments, the release liner may be a split release liner comprising a minority portion and a majority portion. According to various embodiments, a user may remove the minority portion of the release liner to expose a minority portion of the protective film coated with an adhesive. The user may then align the protective film with respect to a surface. The minority portion of the protective film may then be adhered to a portion of the surface using the adhesive. After ensuring the protective film is properly aligned, the majority portion of the split release liner may be removed. The exposed majority portion of the protective film coated with the adhesive may then be adhered to the surface.

According to some embodiments, the opposing tabs may be used to adjust the alignment of the protective film before and after the protective film has been adhered to the surface. According to other embodiments, once adhered, the alignment of the protective film may not be easily adjusted. Additionally, one or more selectively removable supplemental tabs may be utilized in addition to the two opposing tabs.

Once the protective film is aligned and adhered, the opposing tabs, and any supplemental tabs, may be removed. According to some embodiments, the opposing tabs may be selectively removed from the top surface of the protective film. According to alternative embodiments, the opposing tabs may be formed as extensions of the protective film. According to such embodiments, the opposing tabs may be torn or cut along a perforated or scored edge.

Throughout the disclosure, numerous examples are provided with reference to a PED resembling that of a touch screen device; however, a size, shape, and/or configuration of a screen protector may be adapted to fit on any of a wide variety of devices. For example, a screen protector may be adhered to portions of a laptop computer, a camera, a touch screen device, a mobile phone, a personal digital assistant, and/or other surfaces requiring film protection. Moreover, a protective film as described herein may be adhered to any surface of an electronic device. For example, it may be desirable to adhere a protective film to the display screen of a PED as well as to a rear and/or side portion of the PED. Accordingly, a screen protector as described herein is not limited to protecting displays of PEDs, but rather may be adapted to protect any of a wide variety of surfaces.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. In particular, an “embodiment” may be a system, an article of manufacture (such as a computer-readable storage medium), a method, and/or a product of a process.

Throughout this specification the term “adhesive” and “adhere” may refer to any of a wide variety of substances and/or methods for joining two components or materials. As used herein, an adhesive may be used to adhere two components or materials to one another permanently, semi-permanently, for a fixed time period, or temporarily. Any of a wide variety of adhesives may be used, including solvent based adhesives, polymer dispersion adhesives, emulsion adhesives, contact adhesives, hot adhesives, and pressure sensitive adhesives. For example, a removable pressure sensitive adhesive may be employed that could allow a protective film to be selectively removed months or even years after its initial adhesion to a PED.

In some cases, well-known features, structures or operations are not shown or described in detail. Furthermore, the described features, structures, or operations may be combined in any suitable manner in one or more embodiments. It will also be readily understood that the components of the embodiments as generally described and illustrated in the figures herein could be arranged and designed in a wide variety of different configurations.

The embodiments of the disclosure are best understood by reference to the drawings, wherein like parts are designated by like numerals throughout. It will be readily understood that the components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless specifically stated.

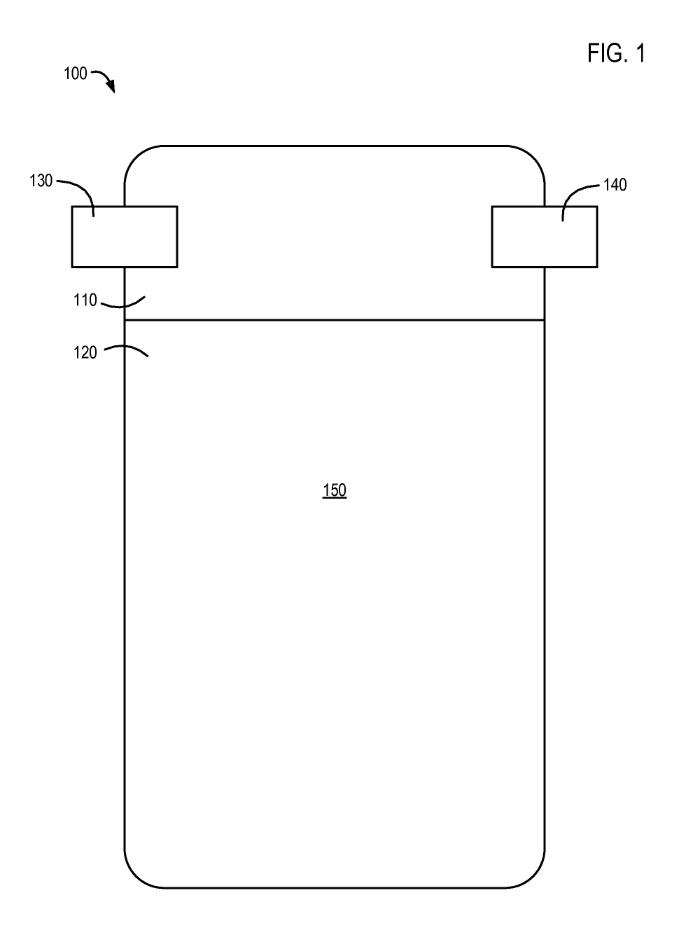

FIG. 1 illustrates a top view of an exemplary film assembly 100 configured with a split release liner 110 and 120, a left tab 130, and an opposing right tab 140. As illustrated, a split release liner may comprise a minority portion 110 and a majority portion 120 that may be selectively and independently removed from an underside of protective film 150. According to various embodiments, the underside of protective film 150 may be coated with an adhesive configured to selectively adhere protective film 150 to a surface.

Minority portion 110 and majority portion 120 of split release liner 150 may be configured to line the adhesive prior to adhesion. Accordingly, minority portion 110 and majority portion 120 of the split release liner may be selectively and independently removed in order to expose the adhesive located on the underside of protective film 150. According to various embodiments, minority portion 110 and majority portion 120 of the split release liner may or may not contain an active release agent.

Protective film 150 may be transparent or include any of a wide variety of colors and/or designs. According to various embodiments, protective film 150 may be configured to adhere to and cover a display, such as those commonly found on portable electronic devices. Additionally, protective film 150 may be configured to function with touch screens, including those touch screens utilizing surface acoustic waves, changes in capacitance, and changes in resistance.

Furthermore, an upper surface of protective film 150 may be configured with a particular texture or coating. For example, the upper surface of protective film 150 may include a top coating configured to provide a rough surface, a superior grip, a matte appearance, a glossy appearance, reduced glare, UV protection, scratch resistance, anti-bacterial properties, an oleographic appearance, an oleophobic surface, and/or other upper surface properties. The top coating may include an additional layer, material, and/or chemical configured to provide a particular benefit.

While not specifically illustrated in FIG. 1, it will be readily appreciated that the size, shape, and thickness of film assembly 100, and specifically of protective film 150 may be adapted to fit on any of a wide variety of surfaces. For instance, film assembly 100, and specifically protective film 150, may include one or more cutouts, protrusions, intrusions, and/or separate pieces in order to fit a specific surface. As a specific example, cutouts and/or protrusions may be formed in protective film 150 to accommodate any number of input buttons and/or switches. According to various embodiments, it may be desirable to adapt the specific dimensions of protective film 150 to create a near-exact fit on a surface of a portable electronic device.

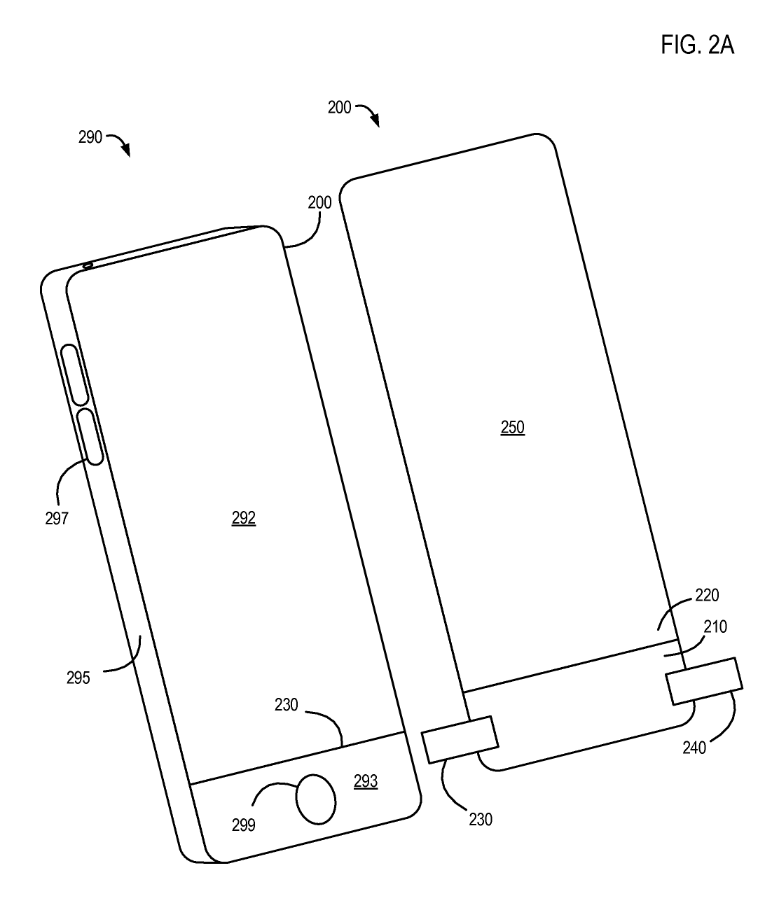

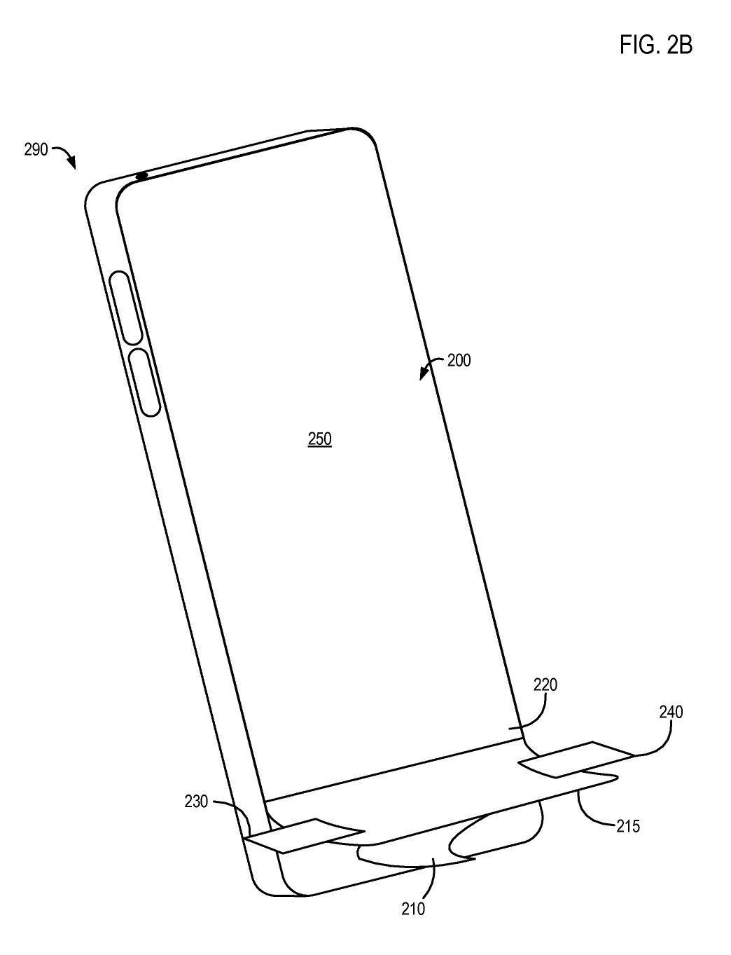

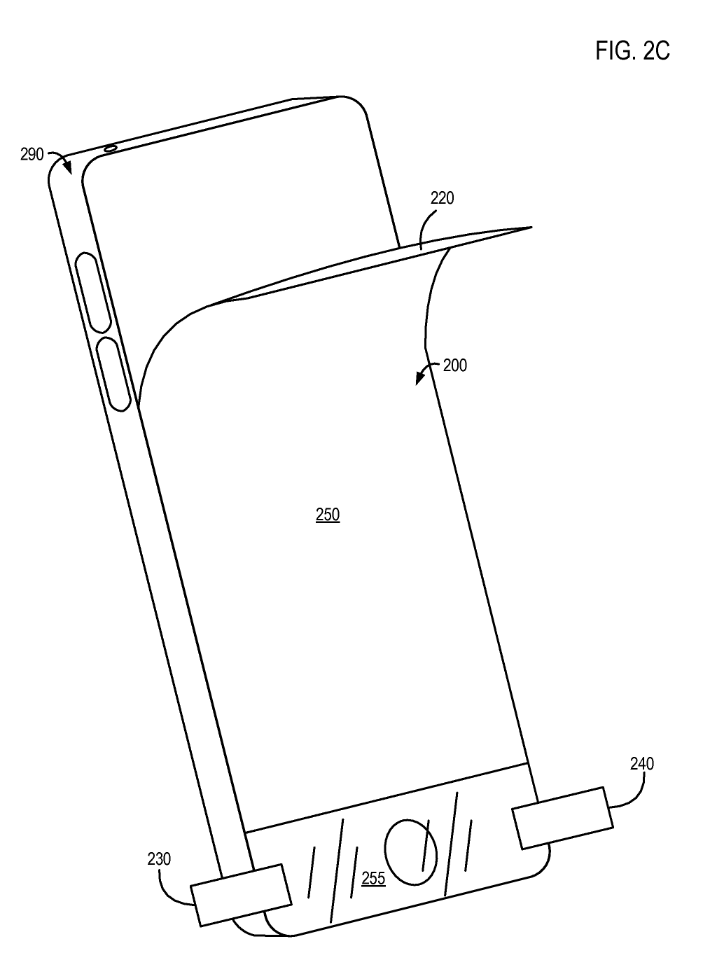

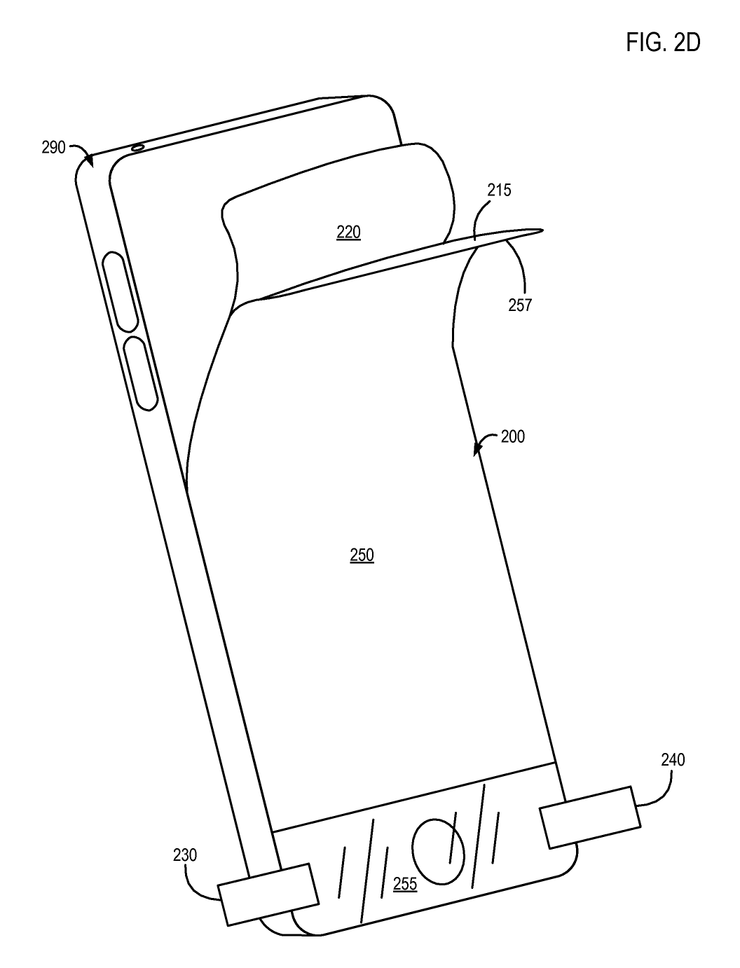

FIG. 2A illustrates a perspective view of an exemplary film assembly 200 positioned above a PED 290. According to various embodiments, PED 290 may be substituted with any of a wide variety of electronic devices, including a laptop computer, a camera, a touch screen device, a mobile phone, and/or a personal digital assistant. Film assembly 200 may comprise a protective film 250, a minority portion 210 and a majority portion 220 of a split release liner, an adhesive, a left tab 230, and an opposing right tab 240.

Film assembly 200 may include a protective film 250 configured to cover one or more surfaces of PED 290. For instance, protective film 250 may be configured with an appropriate size and shape to cover a display screen 292 of PED 290, a front surface 293 of PED 290, and/or wrap around sides 295 of PED 290. Furthermore, one or more film assemblies 200 may be utilized to provide complete coverage of every surface of PED 290. According to various embodiments, film assembly 200 and/or protective film 250 may include protrusions, intrusions, and/or cutouts configured to accommodate various design aspects of PED 290. For example, protective film 250 may be designed to cover display screen 292 and wrap around sides 295 of PED 290 and include appropriate cutouts to accommodate various buttons 297. Similarly, protective film 250 may include a circular cutout to accommodate button 299, or button 299 may be covered by protective film 250 but still be capable of being actuated. A film assembly configured to accommodate a more complex PED may include numerous cutouts and/or protrusions.

FIG. 2B illustrates PED 290 and film assembly 200 with a minority portion 210 of the split release liner partially removed from an adhesive 215 on an underside of protective film 250. According to various embodiments, minority portion 210 may be peeled back from adhesive 215 prior to adhering the exposed portion of protective film 250 to a surface of PED 290. As previously described, the split release liner may comprise minority portion 210 and majority portion 220. Majority portion 220 may comprise a single larger section of split release liner, as illustrated, or it may comprise multiple sections of an independently removable release liner.

According to various embodiments, a release liner may include an active or passive release agent configured to provide a release effect against sticky materials, such as adhesive 215. Accordingly, minority portion 210 may be peeled away from protective film 250 to expose adhesive 215 without retaining adhesive 215 or without significantly diminishing the adhesive properties thereof.

FIG. 2C illustrates a perspective view film assembly 200 with a minority portion 255 of protective film 250 adhered to PED 290. According to various embodiments, opposing tabs 230 and 240 may be used to align minority portion 255 of protective film 250 with respect to a surface of PED 290 prior to adhesion. According to some embodiments, opposing tabs 230 and 240 may be used to align protective film 250 with respect to the surface of PED 290 for a limited time after adhesion. The size of minority portion 255 relative to the remaining portion of protective film 250 may be adapted to accommodate a specific surface, type of PED 290, and/or type of adhesive used.

FIG. 2D illustrates a perspective view of PED 290 and film assembly 200 as majority portion 220 of the split release liner is removed. According to various embodiments, majority portion 220 may comprise a single large section of split release liner, as illustrated, or it may comprise multiple sections of independently removable release liner. As majority portion 220 of the split release liner is peeled away, adhesive 215 is exposed on the underside of a majority portion 257 of protective film 250.

Adhesive 215 may comprise any of wide variety of adhesives, including solvent based adhesives, polymer dispersion adhesives, emulsion adhesives, contact adhesives, hot adhesives, and pressure sensitive adhesives. For example, a removable pressure sensitive adhesive may allow a protective film to be selectively removed days, months, or even years after its initial adhesion to PED 290. Depending on the surface of PED 290 and/or the type of adhesive 215 utilized, adhesive 215 may be configured to adhere protective film 250 to the surface of PED 290 permanently, semi-permanently, for a fixed time period, or temporarily. Moreover, adhesive 215 may be configured as a single-use adhesive, or as a reusable adhesive, allowing protective film 250 to be removed and replaced as desired.

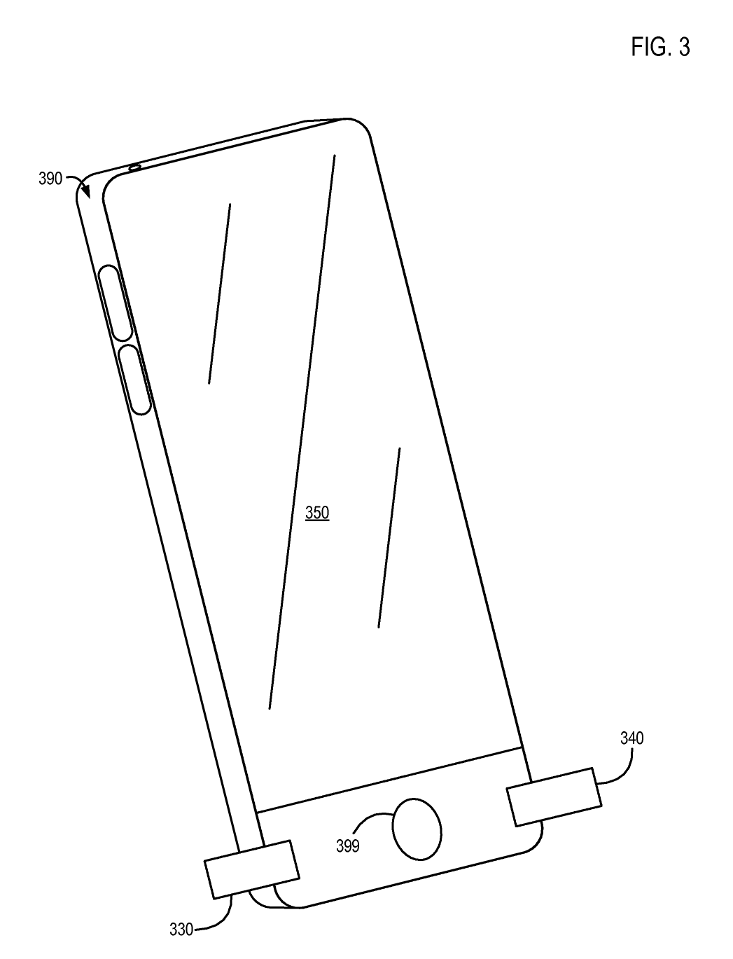

FIG. 3 illustrates a perspective view of a protective film 350 fully adhered to a display screen of a PED 390. As illustrated, opposing tabs 330 and 340 may be attached to protective film 350. According to some embodiments, opposing tabs 330 and 340 may be used to align protective film 350 with respect to PED 390 prior to adhesion. According to some embodiments, opposing tabs 330 and 340 may be used to align protective film 350 with respect to the surface of PED 390 for a limited time after adhesion. The size, shape, and configuration of opposing tabs 330 and 340 may be adapted to accommodate a particular application. For example, opposing tabs 330 and 340 may be parallel to the plane of protective film 350, or they, or portions thereof, may be at an angle with respect to protective film 350. Furthermore, opposing tabs 330 and 340 may be configured with any size and/or shape to provide a suitable area for a user to grasp and manipulate the orientation of protective film 350.

As previously described, once protective film 350 is aligned with respect to the surface of PED 390 and is fully adhered, opposing tabs 330 and 340 may be removed. According to some embodiments, opposing tabs 330 and 340 may be separate pieces of material capable of being selectively removed from the top surface of protective film 350. Alternatively, opposing tabs 330 and 340 may be formed as extensions of protective film 350 and may be torn or cut along an edge. The edge may be perforated or scored to facilitate the removal of opposing tabs 330 and 340.

Additionally, protective film 350 may include a circular cutout to accommodate button 399, or button 399 may be covered by protective film 350. A protective film 350 configured to accommodate a more complex PED may include numerous cutouts and/or protrusions.

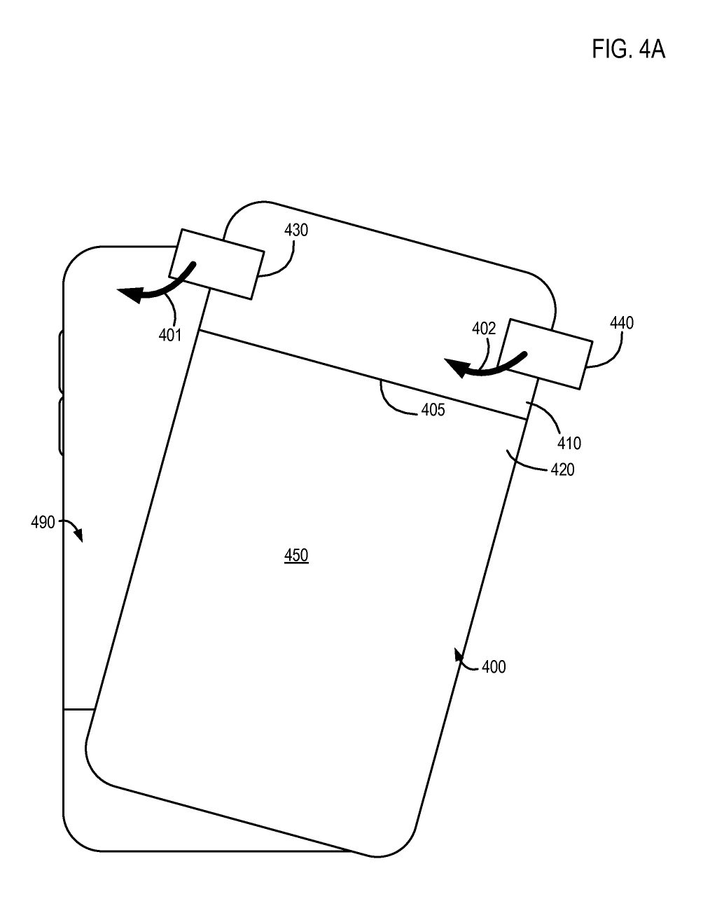

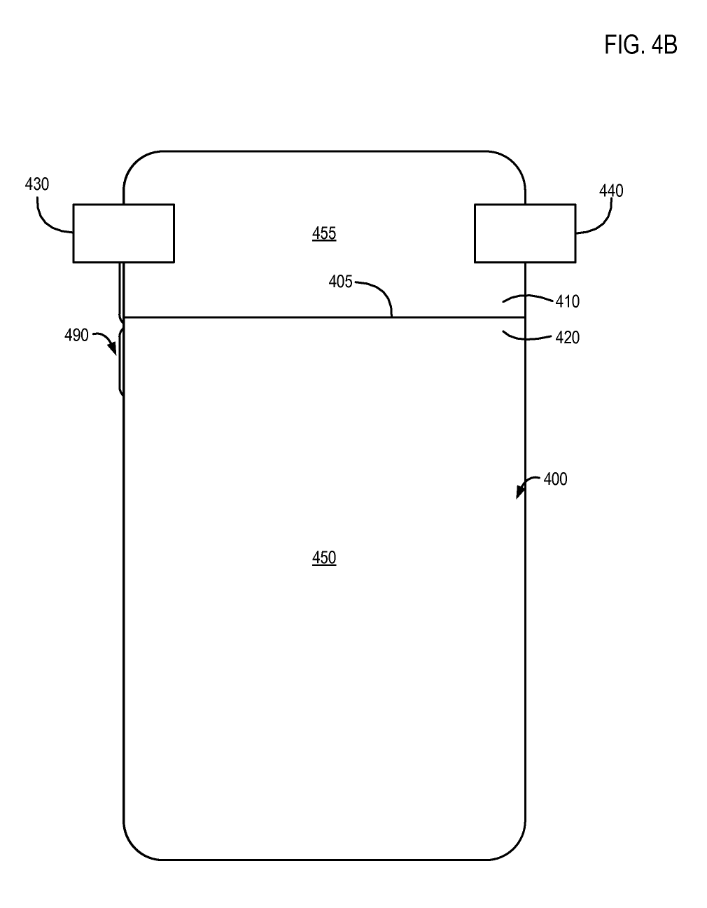

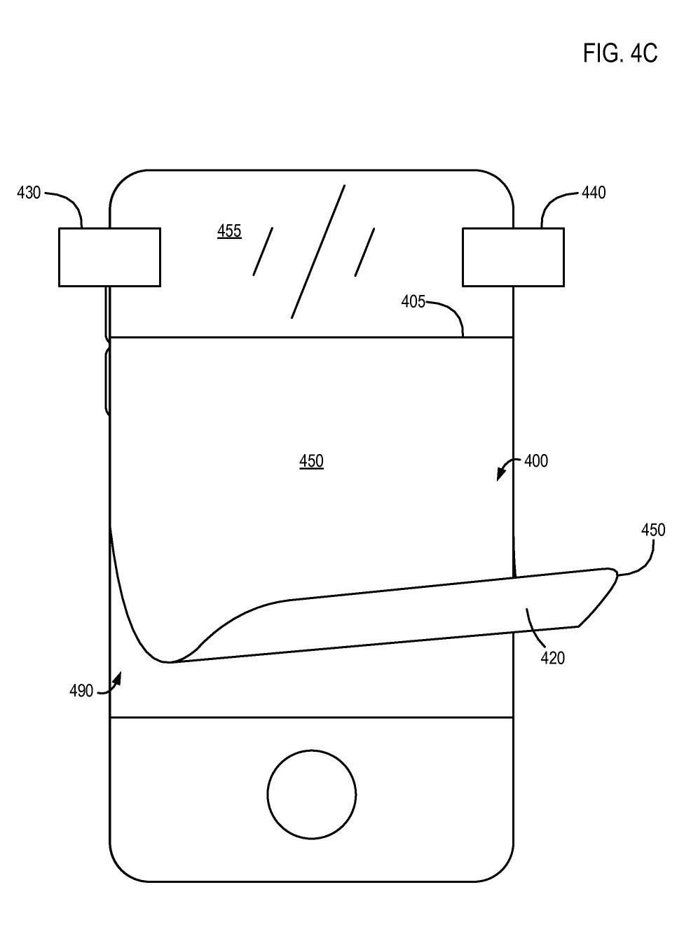

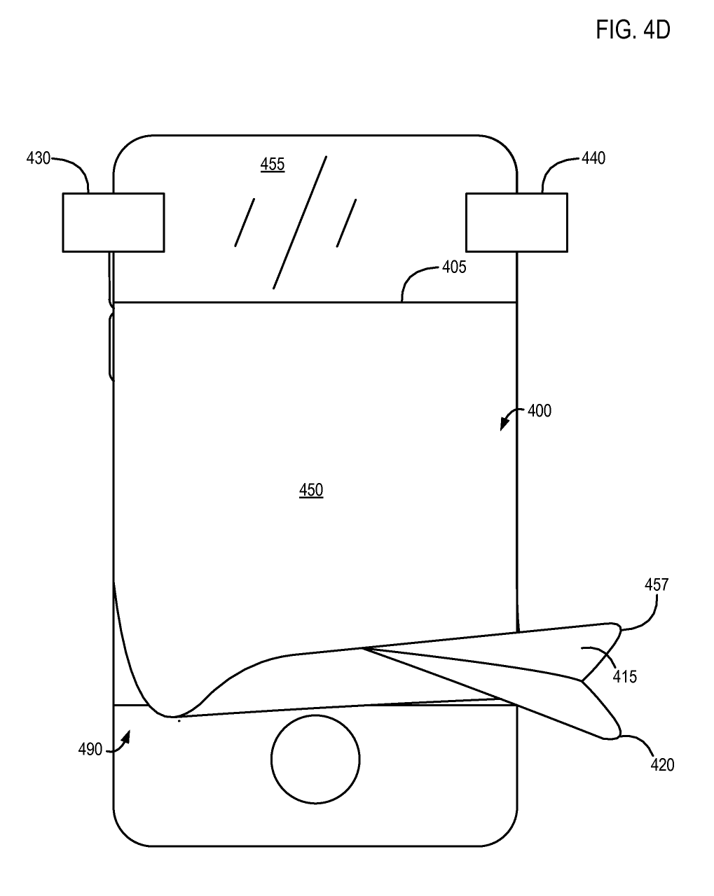

FIG. 4A illustrates a top view of an exemplary film assembly 400 slightly misaligned with respect to an underlying PED 490. As previously described, film assembly 400 may include a protective film 450 and removable opposing tabs 430 and 440. An underside of protective film 450 may be coated with an adhesive configured to adhere protective film 450 to a surface of PED 490. The underside of the adhesive may be lined with a split release liner divided along divide line 405 into a minority portion 410 and a majority portion 420.

Similar to previous embodiments, opposing tabs 430 and 440 may be separate pieces of material configured to be selectively removed from the top surface of protective film 450 or formed as extensions of protective film 450. In either case, once protective film 450 is aligned and fully adhered to PED 490, opposing tabs 430 and 440 may be removed.

As illustrated, a user may grasp opposing tabs 430 and 440 to manually rotate film assembly 400 in the direction of arrows 401 and 402 in order to align protective film 450 with respect to a surface of PED 490. In FIG. 4B, film assembly 400 is shown aligned with respect to the surface of PED 490. Minority portion 410 of split release liner may be removed allowing a minority portion 455 of protective film 450 to be adhered to the surface of PED 490.

FIG. 4C illustrates a top view of film assembly 400 with minority portion 455 of protective film 450 adhered to PED 490. According to various embodiments, a user may grasp opposing tabs 430 and 440 in order to lower minority portion 455 of protective film 450 onto PED 490. Opposing tabs 430 and 440 reduce the difficulty in handling the relatively thin protective film 450 coated with adhesive. For example, opposing tabs 430 and 440 facilitate the alignment of protective film 450 and reduce the likelihood of the adhesive accidentally contacting other surfaces, such as the user's own hand.

FIG. 4D illustrates a top view of film assembly 400 as a majority portion 420 of the split release liner is removed. As previously described, majority portion 420 may comprise a single large section of split release liner, as illustrated, or multiple sections of an independently removable release liner. As majority portion 420 of split release liner is peeled away, adhesive 415 is exposed on the underside of a majority portion 457 of protective film 450.

Adhesive 415 may comprise any of wide variety of adhesives, including solvent based adhesives, polymer dispersion adhesives, emulsion adhesives, contact adhesives, hot adhesives, and pressure sensitive adhesives. According to various embodiments, adhesive 415 may adhere protective film 450 to the surface of PED 490 permanently, semi-permanently, temporarily, or for a fixed time period. According to some embodiments, protective film 450 may include one or more supplementary tabs in addition to opposing tabs 430 and 440. Accordingly, the one or more supplementary tabs may facilitate a user as a majority portion 457 of protective film 450 is adhered to the surface of PED 490. The supplementary tabs may then be removed.

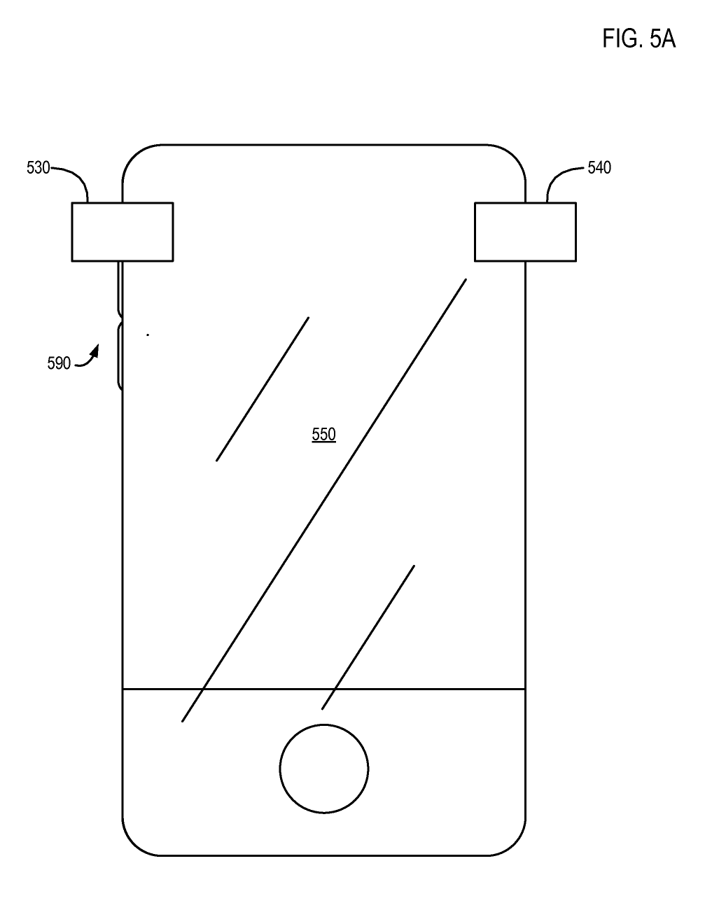

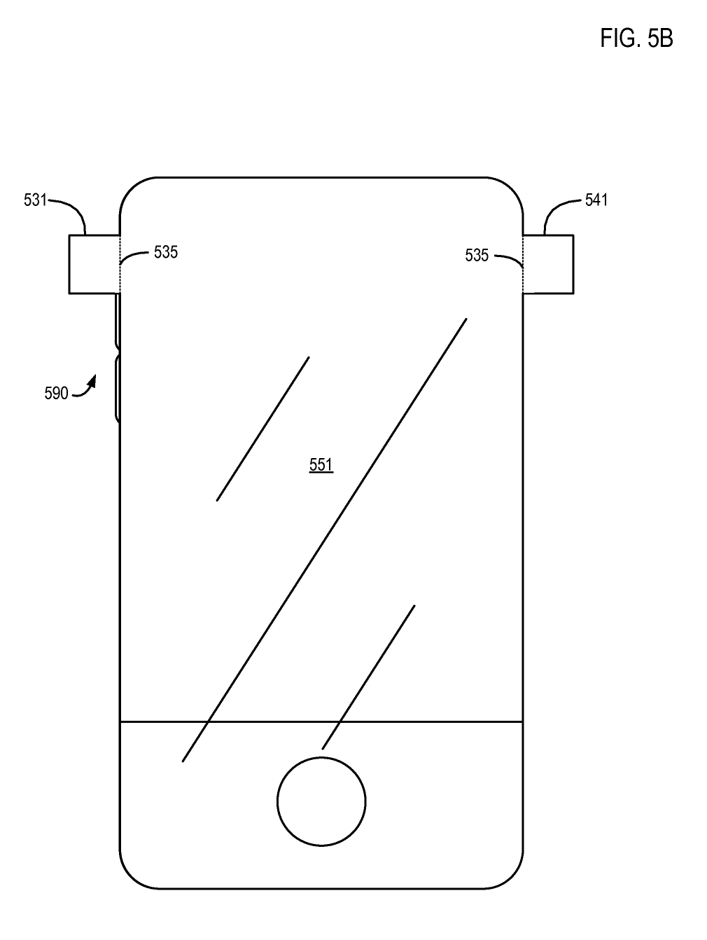

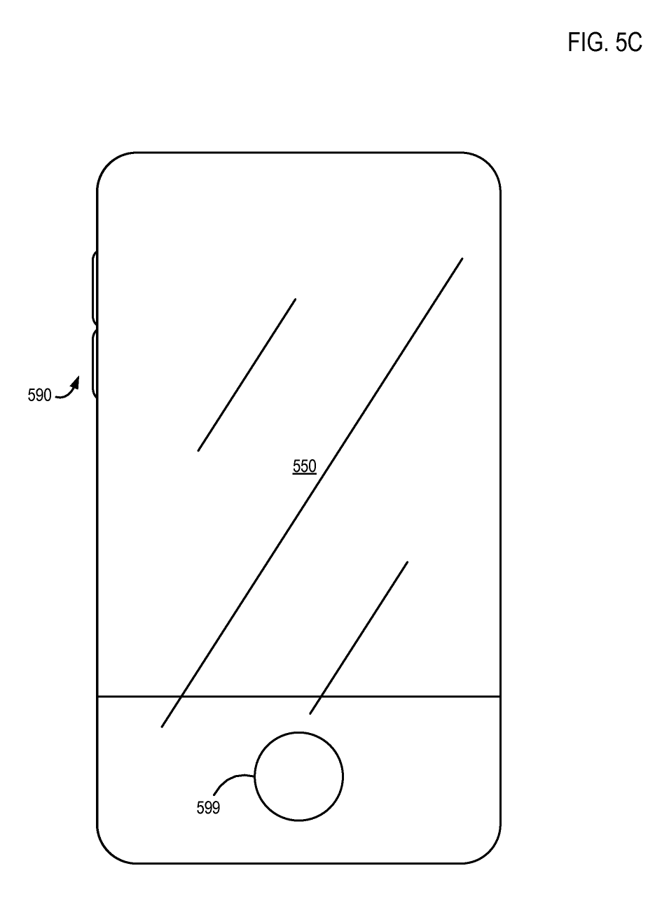

FIG. 5A illustrates a top view of a protective film 550 fully adhered to a display screen of a PED 590 with opposing tabs 530 and 540 in place, according to one embodiment. According to various embodiments, protective film 550 may be adhered to any of a wide variety of surfaces and is not limited to protecting display screens. Particularly when used with display screens, protective film 550 and the underlying adhesive may be transparent. Alternatively, and when used on other surfaces, protective film 550 may be configured with any number of colors and/or designs. Moreover, the upper surface of protective film 550 may include a top coating configured to provide a rough surface, a superior grip, a matte appearance, a glossy appearance, reduced glare, UV protection, scratch resistance, anti-bacterial properties, an oleographic appearance, an oleophobic surface, and/or other surface properties.

Opposing tabs 530 and 540 may be utilized to align protective film 550 with respect to PED 590 before and/or after protective film 550 has been adhered to PED 590. Once aligned, opposing tabs 530 and 540, and any potential supplementary tabs, may be removed. FIG. 5A illustrates opposing tabs 530 and 540 as separate pieces of material attached to a top surface of protective film 550. According to such a configuration, opposing tabs 530 and 540 may be configured to be removed from the top surface of protective film 550.

FIG. 5B illustrates a top view of an alternative protective film 551 fully adhered to PED 590. As illustrated in FIG. 5B, protective film 551 includes alternative opposing tabs 531 and 541 formed as extensions of protective film 551. According to such an embodiment, opposing tabs 531 and 541 may be removed by tearing or cutting along an edge 535 of protective film 551. As illustrated, edge 535 may be perforated or scored to facilitate the removal of opposing tabs 531 and 541.

FIG. 5C illustrates protective film 550 fully adhered to a display screen of PED 590 with opposing tabs 530 and 540 removed. As illustrated, protective film 550 may be configured with any number of cutouts and in any number of shapes in order to create a relatively tight fit around the perimeter of the PED 590. For example, protective film 550 may include a cutout to accommodate button 599. Additionally, protective film 550 may include one or more separate pieces in order to fit a specific contour of a PED or to cover additional surfaces of a PED.

According to some embodiments, after protective film 550 is adhered to PED 590, an applicator tool, such as a straight edge of a relatively hard material, may be used to smooth the protective film 550 across the surface of the PED 590. The applicator tool may also serve to expel air bubbles that may be trapped between the protective film 550 and the surface of the PED 590.

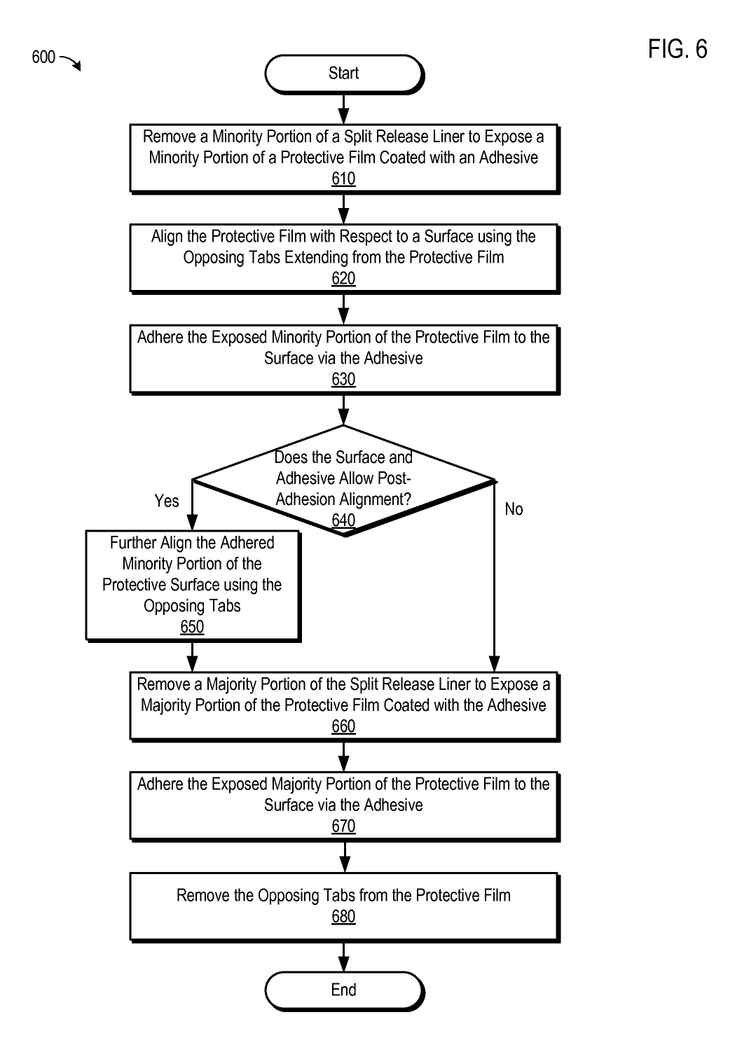

FIG. 6 provides a flow chart of an exemplary method 600 for adhering a protective film to a surface of a PED using removable opposing tabs. A minority portion of a split release liner is removed in order to expose a minority portion of a protective film coated with an adhesive, at 610. The protective film is aligned with respect to a surface of a PED using opposing tabs extending from the protective film, at 620. The exposed minority portion of the protective film may be adhered to the surface of the PED via the adhesive, at 630. If the type of adhesive and/or the surface allows for post-adhesion alignment, at 640, then the adhered minority portion of the protective surface may be further aligned if necessary using the opposing tabs, at 650.

Once the minority portion of the protective surface is aligned and adhered, a majority portion of the split release liner may be removed to expose a majority portion of the protective film coated with the adhesive, at 660. The majority portion of the protective film may then be adhered to the surface of the PED via the underlying adhesive, at 670. Once the protective film is properly aligned and adhered to the surface of the PED, the opposing tabs may be removed, at 680.

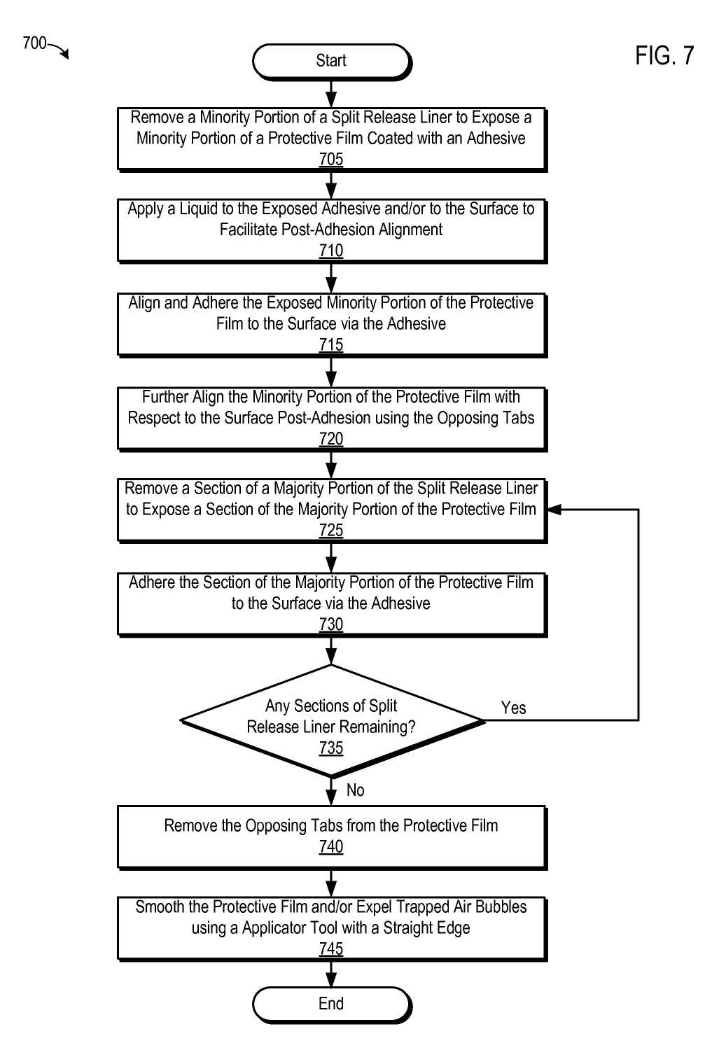

FIG. 7 provides a flow chart of an exemplary method 700 including various optional steps for adhering a protective film to a surface of a PED using removable opposing tabs. A minority portion of a split release liner is removed in order to expose a minority portion of a protective film coated with an adhesive, at 705. A liquid may be applied to exposed adhesive and/or to the surface of the PED to facilitate aligning the protective film with respect to the PED post-adhesion, at 710. The exposed minority portion of the protective film may be aligned and then adhered to the surface of the PED via the adhesive, at 715. The adhered minority portion of the protective surface may be further aligned if necessary using the opposing tabs, at 720.

Once the minority portion of the protective surface is aligned and adhered, a first section of the majority portion of the split release liner may be removed to expose a first section of the majority portion of the protective film coated with the adhesive, at 725. Each section of the majority portion of the protective film may be successively adhered to the surface of the PED via the underlying adhesive, at 730, until each section of the majority portion of the split release liner has been removed, at 735. Once the protective film is properly aligned and fully adhered to the surface of the PED, the opposing tabs may be removed, at 740. An applicator tool may then be used to smooth the protective film and/or to expel air bubbles trapped between the protective film and the surface, at 745.

According to various embodiments, one or more steps in the methods described in conjunction with FIGS. 6 and 7 may be omitted, repeated, and/or executed out of order. For example, each successive section of exposed adhesive may have a liquid applied to it even though applying a liquid is only illustrated as occurring once in FIG. 7.

The above description provides numerous specific details for a thorough understanding of the embodiments described herein. However, those of skill in the art will recognize that one or more of the specific details may be omitted, modified, and/or replaced by a similar process, system, or component. In many instances the order of steps and/or actions of the methods of use described herein may be interchanged with one another.

What is claimed:

1. A film assembly for a portable electronic device, comprising:
a protective film configured to protected a surface;
a first tab and an opposing second tab extending from the protective film configured to facilitate the alignment of the protective film with respect to the surface;
an adhesive coating an underside of the protective film configured to adhere the protective film to the surface;
a split release liner comprising a first portion and a second portion configured to selectively line the adhesive prior to adhesion;
wherein the first portion of the split release liner may be removed independently from the second portion of the split release liner; and
wherein the first and second opposing tabs are configured to be selectively removed from the protective film.

2. The film assembly of claim 1, wherein the first portion of the split release liner is a minority portion of the split release liner and the second portion of the split release liner is a majority portion of the split release liner.

3. The film assembly of claim 1, further comprising:
an applicator tool having a straight edge configured to smooth the protective film along the surface to expel air pockets.

4. The film assembly of claim 1, further comprising:
a liquid configured to be applied to the adhesive in order to facilitate aligning the protective film with respect to the surface.

5. The film assembly of claim 1, wherein the protective film comprises one of polyester, polypropylene, and polyethylene.

6. The film assembly of claim 1, wherein the adhesive comprises one of a solvent based adhesive, a polymer dispersion adhesive, an emulsion adhesive, a contact adhesive, a hot adhesive, a reactive adhesive, and a pressure sensitive adhesive.

7. The film assembly of claim 1, wherein the adhesive comprises a removable pressure sensitive adhesive.

8. The film assembly of claim 1, wherein the protective film is substantially transparent.

9. The film assembly of claim 1, wherein the second portion of the split release liner comprises at least two sections of release liner.

10. The film assembly of claim 1, further comprising a third tab extending from the protective film configured to facilitate the alignment of the protective film with respect to the surface; and
wherein the third tab is configured to be selectively removed from the protective film following adhesion of the protective film to the surface.

11. The film assembly of claim 1, further comprising a top coating on an upper surface of the protective film.

12. A method for applying a protective film to a surface of a portable electronic device, comprising:
removing a first portion of a split release liner to expose a first portion of a protective film coated with an adhesive;
aligning the protective film with respect to a surface using first and second opposing tabs extending from the protective film;
adhering the first portion of the protective film to the surface using the adhesive;
removing a second portion of the split release liner to expose a second portion of the protective film coated with the adhesive;
adhering the second portion of the protective film to the surface using the adhesive;
removing the first and second opposing tabs extending from the protective film.

13. The method of claim 12, wherein the first portion of the split release liner is a minority portion of the split release liner and the second portion of the split release liner is a majority portion of the split release liner.

14. The method of claim 12, further comprising:
using an applicator tool to smooth the protective film on the surface to expel air pockets.

15. The method of claim 12, further comprising:
applying a liquid to the adhesive to facilitate aligning the protective film with respect to the surface.

16. The method of claim 12, wherein the protective film comprises one of polyester, polypropylene, and polyethylene.

17. The method of claim 12, wherein the adhesive comprises one of a solvent based adhesive, a polymer dispersion adhesive, an emulsion adhesive, a contact adhesive, a hot adhesive, a reactive adhesive, and a pressure sensitive adhesive.

18. The method of claim 12, wherein the adhesive comprises a removable pressure sensitive adhesive.

19. The method of claim 12, wherein the protective film is substantially transparent.

20. The method of claim 13, wherein the majority portion of the split release liner comprises at least two sections of release liner; and
wherein removing the majority portion of the split release liner comprises removing the at least two sections of release liner; and
wherein adhering the second portion of the protective film to the surface may comprise successively adhering sections of the second portion of the protective film as each of the at least two sections of release liner are removed.

21. The method of claim 12, further comprising:
aligning the protective film with respect to the surface using a third tab extending from the protective film; and
removing the third tab from the protective film after the second portion of the protective film has been adhered to the surface.
